(19) United States
(12) Patent Application Publication
(10) Pub. No.: US 2026/0322276 A1
(43) Pub. Date: Oct. 15, 2026

(54) FLYBACK POWER CONVERSION CIRCUIT FOR GENERATING MULTIPLE OUTPUT VOLTAGES AND CONTROL METHOD THEREOF

(71) Applicant: Richtek Technology Corporation, Zhubei City (TW)

(72) Inventors: Kuo-Chi LIU, Hsinchu City (TW); Shui-Mu LIN, Taichung City (TW); Shao-Chun HUANG, New Taipei City (TW)

(21) Appl. No.: 19/444,523

(22) Filed: Jan. 9, 2026

Related U.S. Application Data
(60) Provisional application No. 63/788,854, filed on Apr. 15, 2025.

(30) Foreign Application Priority Data
Sep. 18, 2025 (TW) 114135880

(51) Int. Cl. H02M 3/335

(52) U.S. Cl. CPC H02M 3/33561

(57) ABSTRACT

A power conversion circuit includes a transformer, a primary switch, a first switch, a second switch, and a control circuit. The transformer includes a primary coil and a secondary coil. The primary coil receives an input voltage, and the secondary coil generates a secondary current. The primary switch couples the primary coil to a ground based on a primary control signal. The first switch uses the secondary current to power a first output voltage based on a first signal. The second switch uses the secondary current to power a second output voltage based on a second signal. The control circuit generates the first signal based on the first output voltage, generates the second signal based on the second output voltage, and generates the primary control signal based on the first output voltage and the second output voltage.

### CROSS REFERENCE TO RELATED APPLICATIONS

This application claims the benefit of U.S. Provisional Application No. 63/788,854, filed on Apr. 15, 2025, the entirety of which is incorporated by reference herein.

This Application claims priority of Taiwan Patent Application No. 114135880, filed on Sep. 18, 2025, the entirety of which is incorporated by reference herein.

### BACKGROUND OF THE INVENTION

### Field of the Invention

The disclosure is generally related to a power conversion circuit and a control method thereof, and more particularly it is related to a flyback power conversion circuit for generating multiple output voltages, and a control method thereof.

### Description of the Related Art

Many devices (such as mobile phones, power banks, laptops, digital cameras, tablets, speakers, game consoles, portable computing devices, and wearable devices) require multi-output power conversion circuits. Traditional multi-output flyback power conversion circuits require multiple coils on the secondary side and additional independent voltage regulator circuits to regulate the individual output voltages. This can significantly increase the component costs and the circuit complexity. To reduce costs and circuit complexity, it is necessary to optimize multi-output power conversion circuits.

### BRIEF SUMMARY OF THE INVENTION

The present invention provides a power conversion circuit having multiple output voltages and a control method thereof. Compared to traditional methods that use multiple secondary coils (or multiple transformers) and additional voltage regulators to stabilize the individual output voltages, the multi-output voltage power conversion circuit proposed herein uses a transformer having a single secondary coil and a plurality of switches to power multiple output voltages in a time-division manner. Since this invention uses a transformer having a single secondary coil and a plurality of switches, it significantly reduces costs and circuit complexity, while also improving conversion efficiency. Furthermore, the multiple output voltages of the power conversion circuit proposed herein can be individually programmed.

In an embodiment, a power conversion circuit comprises a transformer, a primary switch, a first switch, a second switch, and a control circuit. The transformer comprises a primary coil and a secondary coil, wherein the primary coil receives an input voltage, and the secondary coil is configured to generate a secondary current. The primary switch couples the primary coil to a ground based on a primary control signal. The first switch powers a first output voltage using the secondary current based on a first signal. The second switch powers a second output voltage using the secondary current based on a second signal. The control circuit generates the first signal based on the first output voltage and generates the second signal based on the second output voltage. The control circuit generates the primary control signal based on the first output voltage and the second output voltage.

According to an embodiment of the present invention, the control circuit comprises a first error amplifier, a first comparator, and a first signal-generation circuit. The first error amplifier generates a first error signal based on the difference between the first output voltage and a first reference voltage. The first comparator compares the first error signal with a first sawtooth wave to generate a first comparison signal. The first signal-generation circuit generates the first signal based on the first comparison signal. When the primary switch is turned off, the control circuit enables the first signal to turn on the first switch. When the first sawtooth wave is not less than the first error signal, the first signal-generation circuit disables the first signal and simultaneously enables the second signal, so that the first switch is turned off and the second switch is turned on.

According to an embodiment of the present invention, the first signal-generation circuit disables the second signal based on the secondary current dropping below the current threshold to turn off the second switch.

According to an embodiment of the present invention, the control circuit further comprises a second error amplifier, an isolation circuit, and a third signal-generation circuit. The second error amplifier generates a second error signal based on the difference between the second output voltage and a second reference voltage. The isolation circuit generates a feedback signal based on the first error signal and the second error signal. The third signal-generation circuit generates the primary control signal based on the feedback signal.

According to an embodiment of the present invention, when the first output voltage is less than the first reference voltage or the second output voltage is less than the second reference voltage, the third signal-generation circuit extends the enable period of the primary control signal, thereby extending the magnetization period of the primary coil.

According to an embodiment of the present invention, the control circuit further comprises a current comparator. The current comparator compares the secondary current with the current threshold to generate a current comparison signal. When the secondary current is less than the current threshold, the first signal-generation circuit disables the second signal based on the current comparison signal, thereby turning off the second switch.

According to an embodiment of the present invention, the control circuit further comprises a second comparator and a second signal-generation circuit. The second comparator compares the second error signal to a second sawtooth wave to generate a second comparison signal. The second signal-generation circuit disables the second signal based on the second comparison signal. When the second sawtooth wave is not less than the second error signal, the second signal-generation circuit disables the second signal, thereby turning off the second switch.

According to another embodiment of the present invention, the power conversion circuit further comprises a third switch. The third switch powers a third output voltage using the secondary current based on a third signal. The control circuit further comprises a third error amplifier. The third error amplifier generates a third error signal based on a difference between the third output voltage and a third reference voltage. When the second signal-generation circuit disables the second signal, the third signal is simultaneously enabled. The isolation circuit generates the feedback signal based on the first error signal, the second error signal, and the third error signal.

According to an embodiment of the present invention, the control circuit further comprises a current comparator. The current comparator compares the secondary current and a current threshold to generate a current comparison signal. When the secondary current is less than the current threshold, the second signal-generation circuit disables the third signal based on the current comparison signal, thereby turning off the third switch.

According to another embodiment of the present invention, the control circuit further comprises a third comparator and a fourth signal-generation circuit. The third comparator compares the third error signal to a third sawtooth wave to generate a third comparison signal. The fourth signal-generation circuit disables the third signal based on the third comparison signal. When the third sawtooth wave is not less than the third error signal, the fourth signal-generation circuit disables the third signal, thereby turning off the third switch.

According to an embodiment of the present invention, the power conversion circuit further comprises a secondary switch. The secondary switch is coupled to the secondary coil in series. When the primary switch is turned on, the secondary switch is turned off. When the primary switch is turned off, the secondary switch is turned on so that the secondary current powers either the first output voltage or the second output voltage.

According to an embodiment of the present invention, the first switch comprises a first rectification transistor and a first blocking transistor. The first rectification transistor comprises a first rectification gate terminal, a first rectification drain terminal, and a first rectification source terminal. The first blocking transistor comprises a first blocking gate terminal, a first blocking drain terminal, and a first blocking source terminal. The first rectification gate terminal receives a first rectification signal, the first rectification drain terminal is coupled to the first blocking drain terminal, and the first rectification source terminal receives the secondary current. The first blocking gate terminal receives a first blocking signal and the first blocking drain terminal is coupled to the first output voltage.

According to an embodiment of the present invention, the second switch comprises a second rectification transistor and a second blocking transistor. The second rectification transistor comprises a second rectification gate terminal, a second rectification drain terminal, and a second rectification source terminal. The second blocking transistor comprises a second blocking gate terminal, a second blocking drain terminal, and a second blocking source terminal. The second rectification gate terminal receives a second rectification signal, the second rectification drain terminal is coupled to the second blocking drain terminal, and the second rectification source terminal receives the secondary current. The second blocking gate terminal receives a second blocking signal, and the second blocking source terminal is coupled to the second output voltage.

According to an embodiment of the present invention, an on-time of the first rectification transistor does not overlap an on-time of the second rectification transistor.

According to an embodiment of the present invention, during a first period, the first rectification transistor and the first blocking transistor are both turned on, causing the secondary current to power the first output voltage. During a second period after the first period, the first rectification transistor is turned off and the first blocking transistor and the second blocking transistor are both turned on, causing the secondary current to power either the first output voltage or the second output voltage having a lower voltage value. During a third period after the second period, the first blocking transistor is turned off and the second rectification transistor is turned on, causing the secondary current to power the second output voltage.

In another embodiment, a control method for controlling a power conversion circuit to convert an input voltage into a first output voltage and a second output voltage is provided. The power conversion circuit comprises a transformer, wherein the transformer comprises a primary coil and a secondary coil. The control method comprises the following steps. The primary coil is magnetized during a magnetization period. After the magnetization period, the first output voltage is powered using a secondary current of the secondary coil. The first output voltage is stopped powering and the second output voltage is started powering based on the first output voltage. The magnetization period is adjusted based on the first output voltage and the second output voltage.

According to an embodiment of the present invention, the control method further comprises the following steps. The second output voltage is stopped powering based on the second output voltage.

According to an embodiment of the present invention, the control method further comprises the following steps. The second output voltage is stopped powering based on the secondary current.

According to an embodiment of the present invention, the step of adjusting the magnetization period based on the first output voltage and the second output voltage further comprises the following steps. A first error signal is generated based on a difference between the first output voltage and the first reference voltage. A second error signal is generated based on a difference between the second output voltage and the second reference voltage. The magnetization period is determined based on the first error signal and the second error signal. When the first output voltage is less than the first reference voltage, extending the magnetization period. When the second output voltage is less than the second reference voltage, extending the magnetization period.

According to an embodiment of the present invention, the step of adjusting the magnetization period based on the first output voltage and the second output voltage further comprises the following steps. Output power of the first output voltage and output power of the second output voltage is determined. When the output power of the first output voltage increases, the magnetization period is extended. When the output power of the second output voltage increases, the magnetization period is extended.

According to an embodiment of the present invention, the secondary current powers the first output voltage through a first rectification transistor and a first blocking transistor, and the secondary current powers the second output voltage through a second rectification transistor and a second blocking transistor. A source terminal of the first rectification transistor receives the secondary current, a drain terminal of the first rectification transistor is coupled to a drain terminal of the first blocking transistor, and a source terminal of the first blocking transistor is coupled to the first output voltage. A source terminal of the second rectification transistor receives the secondary current, a drain terminal of the second rectification transistor is coupled to a drain terminal of the second blocking transistor, and a source terminal of the second blocking transistor is coupled to the second output voltage.

According to an embodiment of the present invention, the control method further comprises the following steps. During a first period, the first rectification transistor and the first blocking transistor are simultaneously turned on, causing the secondary current to power the first output voltage. During a second period after the first period, the first rectification transistor is turned off and the first blocking transistor and the second blocking transistor is turned on, causing the secondary current to power either the first output voltage or the second output voltage having a lower voltage value. During a third period after the second period, the first blocking transistor is turned off and the second rectification transistor is turned on, causing the secondary current to power the second output voltage.

In an embodiment, a power conversion circuit comprises a transformer, a primary switch, a first switch, a second switch, and a control circuit. The transformer comprises a primary coil and a secondary coil, wherein the primary coil receives an input voltage, and the secondary coil is configured to generate a secondary current. The primary switch couples the primary coil to a ground based on a primary control signal. The first switch powers a first output voltage using the secondary current based on a first signal. The second switch powers a second output voltage using the secondary current based on a second signal. The control circuit generates the first signal based on the first output voltage and generates the second signal based on the second output voltage. The control circuit generates the primary control signal based on the first output voltage and the second output voltage.

According to an embodiment of the present invention, the control circuit comprises a first error amplifier, a first comparator, and a first signal-generation circuit. The first error amplifier generates a first error signal based on the difference between the first output voltage and a first reference voltage. The first comparator compares the first error signal with a first sawtooth wave to generate a first comparison signal. The first signal-generation circuit generates the first signal based on the first comparison signal. When the primary switch is turned off, the control circuit enables the first signal to turn on the first switch. When the first sawtooth wave is not less than the first error signal, the first signal-generation circuit disables the first signal and simultaneously enables the second signal, so that the first switch is turned off and the second switch is turned on.

According to an embodiment of the present invention, the first signal-generation circuit disables the second signal based on the secondary current dropping below the current threshold to turn off the second switch.

According to an embodiment of the present invention, the control circuit further comprises a second error amplifier, an isolation circuit, and a third signal-generation circuit. The second error amplifier generates a second error signal based on the difference between the second output voltage and a second reference voltage. The isolation circuit generates a feedback signal based on the first error signal and the second error signal. The third signal-generation circuit generates the primary control signal based on the feedback signal.

According to an embodiment of the present invention, when the first output voltage is less than the first reference voltage or the second output voltage is less than the second reference voltage, the third signal-generation circuit extends the enable period of the primary control signal, thereby extending the magnetization period of the primary coil.

According to an embodiment of the present invention, the control circuit further comprises a current comparator. The current comparator compares the secondary current with the current threshold to generate a current comparison signal. When the secondary current is less than the current threshold, the first signal-generation circuit disables the second signal based on the current comparison signal, thereby turning off the second switch.

According to an embodiment of the present invention, the control circuit further comprises a second comparator and a second signal-generation circuit. The second comparator compares the second error signal to a second sawtooth wave to generate a second comparison signal. The second signal-generation circuit disables the second signal based on the second comparison signal. When the second sawtooth wave is not less than the second error signal, the second signal-generation circuit disables the second signal, thereby turning off the second switch.

According to another embodiment of the present invention, the power conversion circuit further comprises a third switch. The third switch powers a third output voltage using the secondary current based on a third signal. The control circuit further comprises a third error amplifier. The third error amplifier generates a third error signal based on a difference between the third output voltage and a third reference voltage. When the second signal-generation circuit disables the second signal, the third signal is simultaneously enabled. The isolation circuit generates the feedback signal based on the first error signal, the second error signal, and the third error signal.

According to an embodiment of the present invention, the control circuit further comprises a current comparator. The current comparator compares the secondary current and a current threshold to generate a current comparison signal. When the secondary current is less than the current threshold, the second signal-generation circuit disables based on the current comparison signal, thereby turning off the third switch.

According to another embodiment of the present invention, the control circuit further comprises a third comparator and a fourth signal-generation circuit. The third comparator compares the third error signal to a third sawtooth wave to generate a third comparison signal. The fourth signal-generation circuit disables the third signal based on the third comparison signal. When the third sawtooth wave is not less than the third error signal, the fourth signal-generation circuit disables the third signal, thereby turning off the third switch.

According to an embodiment of the present invention, the power conversion circuit further comprises a secondary switch. The secondary switch is coupled to the secondary coil in series. When the primary switch is turned on, the secondary switch is turned off. When the primary switch is turned off, the secondary switch is turned on so that the secondary current powers either the first output voltage or the second output voltage.

According to an embodiment of the present invention, the first switch comprises a first rectification transistor and a first blocking transistor. The first rectification transistor comprises a first rectification gate terminal, a first rectification drain terminal, and a first rectification source terminal. The first blocking transistor comprises a first blocking gate terminal, a first blocking drain terminal, and a first blocking source terminal. The first rectification gate terminal receives a first rectification signal, the first rectification drain terminal is coupled to the first blocking drain terminal, and the first rectification source terminal receives the secondary current. The first blocking gate terminal receives a first blocking signal and the first blocking drain terminal is coupled to the first output voltage.

According to an embodiment of the present invention, the second switch comprises a second rectification transistor and a second blocking transistor. The second rectification transistor comprises a second rectification gate terminal, a second rectification drain terminal, and a second rectification source terminal. The second blocking transistor comprises a second blocking gate terminal, a second blocking drain terminal, and a second blocking source terminal. The second rectification gate terminal receives a second rectification signal, the second rectification drain terminal is coupled to the second blocking drain terminal, and the second rectification source terminal receives the secondary current. The second blocking gate terminal receives a second blocking signal, and the second blocking source terminal is coupled to the second output voltage.

According to an embodiment of the present invention, an on-time of the first rectification transistor does not overlap anon-time of the second rectification transistor.

According to an embodiment of the present invention, during a first period, the first rectification transistor and the first blocking transistor are both turned on, causing the secondary current to power the first output voltage. During a second period after the first period, the first rectification transistor is turned off and the first blocking transistor and the second blocking transistor are both turned on, causing the secondary current to power either the first output voltage or the second output voltage having a lower voltage value. During a third period after the second period, the first blocking transistor is turned off and the second rectification transistor is turned on, causing the secondary current to power the second output voltage.

In another embodiment, a control method for controlling a power conversion circuit to convert an input voltage into a first output voltage and a second output voltage is provided. The power conversion circuit comprises a transformer, wherein the transformer comprises a primary coil and a secondary coil. The control method comprises the following steps. The primary coil is magnetized during a magnetization period. After the magnetization period, the first output voltage is powered using a secondary current of the secondary coil. The first output voltage is stopped powering and the second output voltage is started powering based on the first output voltage. The magnetization period is adjusted based on the first output voltage and the second output voltage.

According to an embodiment of the present invention, the control method further comprises the following steps. The second output voltage is stopped powering based on the second output voltage.

According to an embodiment of the present invention, the control method further comprises the following steps. The second output voltage is stopped powering based on the secondary current.

According to an embodiment of the present invention, the step of adjusting the magnetization period based on the first output voltage and the second output voltage further comprises the following steps. A first error signal is generated based on a difference between the first output voltage and the first reference voltage. A second error signal is generated based on a difference between the second output voltage and the second reference voltage. The magnetization period is determined based on the first error signal and the second error signal. When the first output voltage is less than the first reference voltage, extending the magnetization period. When the second output voltage is less than the second reference voltage, extending the magnetization period.

According to an embodiment of the present invention, the step of adjusting the magnetization period based on the first output voltage and the second output voltage further comprises the following steps. Output power of the first output voltage and output power of the second output voltage is determined. When the output power of the first output voltage increases, the magnetization period is extended. When the output power of the second output voltage increases, the magnetization period is extended.

According to an embodiment of the present invention, the secondary current powers the first output voltage through a first rectification transistor and a first blocking transistor, and the secondary current powers the second output voltage through a second rectification transistor and a second blocking transistor. A source terminal of the first rectification transistor receives the secondary current, a drain terminal of the first rectification transistor is coupled to a drain terminal of the first blocking transistor, and a source terminal of the first blocking transistor is coupled to the first output voltage. A source terminal of the second rectification transistor receives the secondary current, a drain terminal of the second rectification transistor is coupled to a drain terminal of the second blocking transistor, and a source terminal of the second blocking transistor is coupled to the second output voltage.

According to an embodiment of the present invention, the control method further comprises the following steps. During a first period, the first rectification transistor and the first blocking transistor are simultaneously turned on, causing the secondary current to power the first output voltage. During a second period after the first period, the first rectification transistor is turned off and the first blocking transistor and the second blocking transistor is turned on, causing the secondary current to power either the first output voltage or the second output voltage having a lower voltage value. During a third period after the second period, the first blocking transistor is turned off and the second rectification transistor is turned on, causing the secondary current to power the second output voltage.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a schematic diagram of a power conversion circuit in accordance with an embodiment of the present invention;

FIG. 2 shows a schematic diagram of a power conversion circuit in accordance with another embodiment of the present invention;

FIG. 3 shows a schematic diagram of a power conversion circuit in accordance with yet another embodiment of the present invention;

FIG. 4 shows a waveform diagram of a power conversion circuit in accordance with an embodiment of the present invention;

FIG. 5 shows a schematic diagram of a power conversion circuit in accordance with yet another embodiment of the present invention;

FIG. 6 shows a schematic diagram of a power conversion circuit in accordance with yet another embodiment of the present invention;

FIG. 7 shows a schematic diagram of a power conversion circuit in accordance with yet another embodiment of the present invention;

FIG. 8 shows a schematic diagram of a power conversion circuit in accordance with yet another embodiment of the present invention;

FIG. 9 shows a waveform diagram of a power conversion circuit in accordance with another embodiment of the present invention; and

FIG. 10 shows a flowchart of a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/- 20% of the stated value, more typically a range of +/- 10%, +/- 5%, +/- 3%, +/- 2%, +/- 1% or +/- 0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

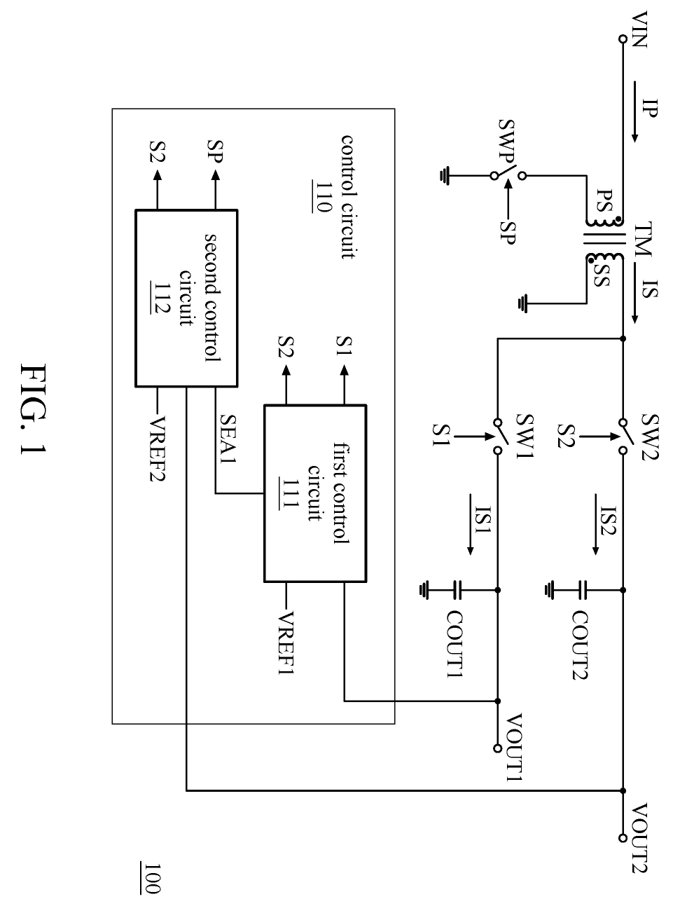

FIG. 1 shows a schematic diagram of a power conversion circuit in accordance with an embodiment of the present invention. As shown in FIG. 1, the power conversion circuit 100 includes a transformer TM, a primary switch SWP, a first switch SW1, a first output capacitor COUT1, a second switch SW2, a second output capacitor COUT2, and a control circuit 110.

The transformer TM includes a primary coil PS and a secondary coil SS. One terminal of the primary coil PS receives an input voltage VIN. The primary switch SWP is coupled between the other terminal of the primary coil PS and a ground. According to an embodiment of the present invention, when the primary switch SWP is turned on, the primary coil PS (i.e., the transformer TM) is magnetized, causing the primary current IP to increase. According to another embodiment of the present invention, when the primary switch SWP is turned off, the primary coil PS (i.e., the transformer TM) is demagnetized, causing the secondary coil SS to generate a secondary current IS. In an embodiment, the transformer TM has only a single secondary coil SS and no other secondary coil. In other words, the transformer TM has only one secondary coil SS.

When the transformer TM is demagnetized, the first switch SW1 and the second switch SW2 are turned on in a time-sharing manner, causing the secondary current IS to generate a first supply current IS1 and a second supply current IS2 at different times. These currents are configured to charge the first output capacitor COUT1 and the second output capacitor COUT2, respectively, thereby generating a first output voltage VOUT1 and a second output voltage VOUT2. The control circuit 110 generates a first signal S1 based on the first output voltage VOUT1, a second signal S2 based on the second output voltage VOUT2, and a primary control signal SP based on both the first and second output voltages VOUT1 and VOUT2, thereby controlling the first switch SW1, the second switch SW2, and the primary switch SWP, respectively.

As shown in FIG. 1, the control circuit 110 includes a first control circuit 111 and a second control circuit 112. The first control circuit 111 generates the first signal S1 and the second signal S2 based on the first output voltage VOUT1, and generates a first error signal SEA1 based on the difference between the first output voltage VOUT1 and the first reference voltage VREF1. The second control circuit 112 generates a primary control signal SP based on the first error signal SEA1, the second output voltage VOUT2, and the second reference voltage VREF2, and generates a second signal S2 based on the second output voltage VOUT2.

According to some embodiments of the present invention, the first control circuit 111 determines the on-time of the first switch SW1 based on the first output voltage VOUT1, the second control circuit 112 determines the on-time of the second switch SW2 based on the second output voltage VOUT2, and the second control circuit 112 further determines the on-time of the primary switch SWP based on the difference between the first output voltage VOUT1 and the first reference voltage VREF1 and the difference between the second output voltage VOUT2 and the second reference voltage VREF2.

According to an embodiment of the present invention, the power conversion circuit 100 may be a flyback power conversion circuit. For the sake of simplicity, the description herein refers to the power conversion circuit 100 generating the first output voltage VOUT1 and the second output voltage VOUT2, and is not intended to be limited thereto. According to other embodiments of the present invention, the power conversion circuit 100 may also generate any number of output voltages.

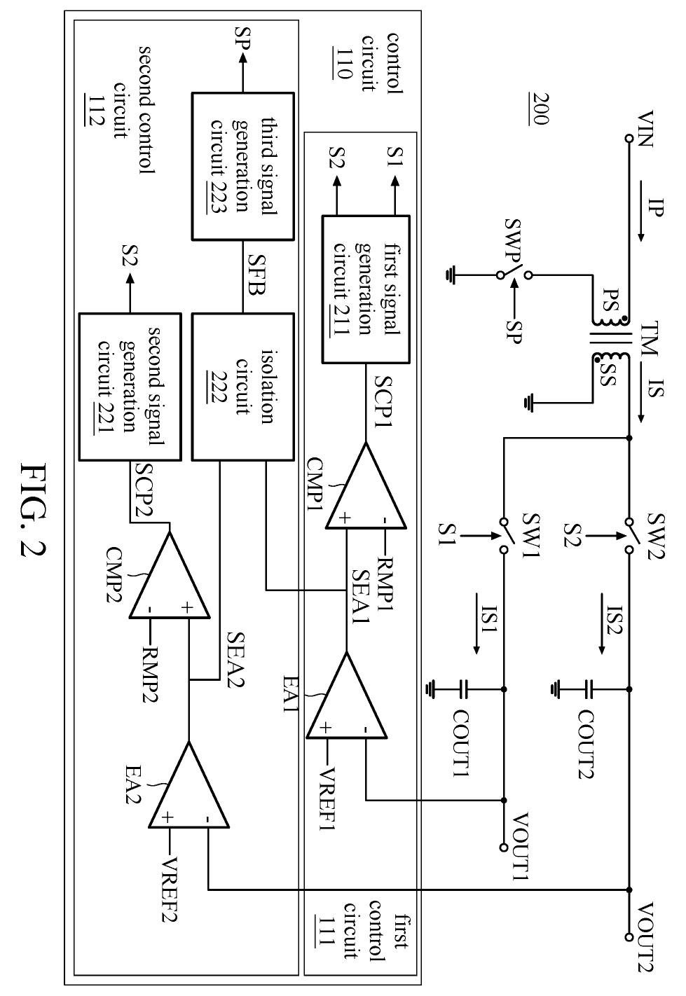

FIG. 2 shows a schematic diagram of a power conversion circuit in accordance with another embodiment of the present invention. Compared with the power conversion circuit 100 of FIG. 1, the first control circuit 111 of the power conversion circuit 200 includes a first error amplifier EA1, a first comparator CMP1, and a first signal-generation circuit 211.

The first error amplifier EA1 generates a first error signal SEA1 based on the difference between the first output voltage VOUT1 and the first reference voltage VREF1. According to an embodiment of the present invention, when the first output voltage VOUT1 decreases, the first error signal SEA1 increases. According to another embodiment of the present invention, when the first output voltage VOUT1 increases, the first error signal SEA1 decreases.

In other words, the first error amplifier EA1 amplifies the difference between the first output voltage VOUT1 and the first reference voltage VREF1 to generate the first error signal SEA1. A first comparator CMP1 compares a first error signal SEA1 with a first sawtooth wave RMP1 to generate a first comparison signal SCP1. A first signal-generation circuit 211 generates a first signal S1 and a second signal S2 based on the first comparison signal SCP1.

As shown in FIG. 2, the second control circuit 112 includes a second error amplifier EA2, a second comparator CMP2, a second signal-generation circuit 221, an isolation circuit 222, and a third signal-generation circuit 223. The second error amplifier EA2 generates a second error signal SEA2 based on the difference between a second output voltage VOUT2 and a second reference voltage VREF2.

The second error amplifier EA2 generates the second error signal SEA2 based on the second output voltage VOUT2 and the second reference voltage VREF2. According to an embodiment of the present invention, when the second output voltage VOUT2 decreases, the second error signal SEA2 increases. According to another embodiment of the present invention, when the second output voltage VOUT2 increases, the second error signal SEA2 decreases.

In other words, the second error amplifier EA2 amplifies the difference between the second output voltage VOUT2 and the second reference voltage VREF2 to generate a second error signal SEA2. The second comparator CMP2 compares the second error signal SEA2 with the second sawtooth wave RMP2 to generate a second comparison signal SCP2. The second signal-generation circuit 221 generates a second signal S2 based on the second comparison signal SCP2.

The isolation circuit 222 generates a feedback signal SFB based on the first error signal SEA1 and the second error signal SEA2. According to an embodiment of the present invention, the isolation circuit 222 may be an optocoupler. According to another embodiment of the present invention, the isolation circuit 222 may be an isolation transformer, where the isolation transformer includes an inductive transformer and a capacitive transformer.

The third signal-generation circuit 223 generates a primary control signal SP based on the feedback signal SFB. In other words, the isolation circuit 222 and the third signal-generation circuit 223 adjust the on-time of the primary switch SWP based on the difference between the first output voltage VOUT1 and the first reference voltage VREF1 and the difference between the second output voltage VOUT2 and the second reference voltage VREF2, thereby changing the magnetization period.

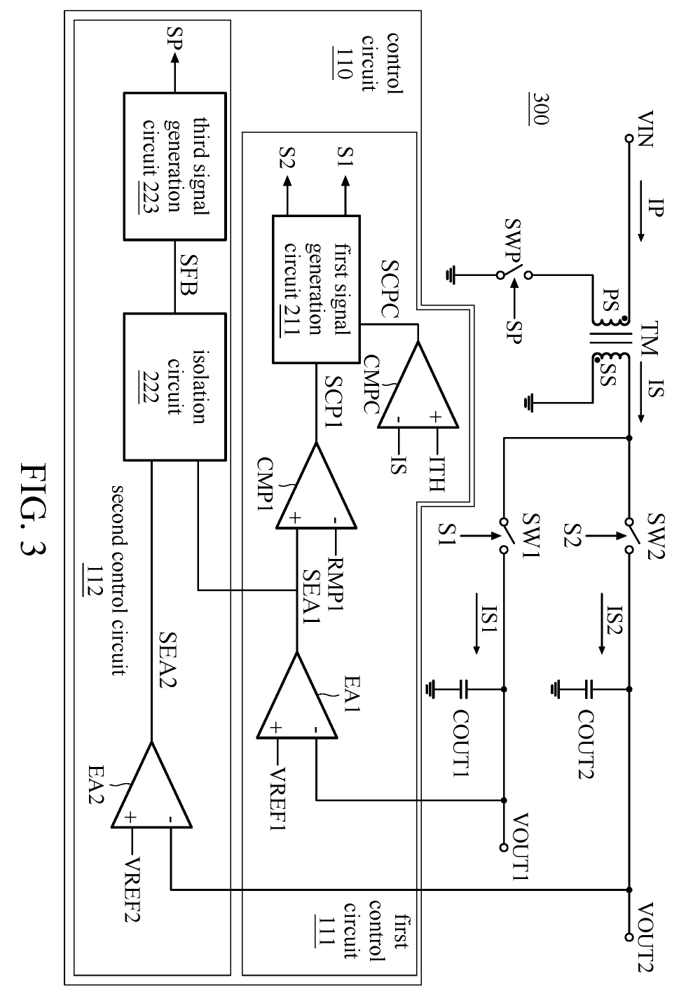

FIG. 3 shows a schematic diagram of a power conversion circuit in accordance with yet another embodiment of the present invention. Compared with the power conversion circuit 200 of FIG. 2, the power conversion circuit 300 uses a current comparator CMPC to replace the second comparator CMP2 and the second signal-generation circuit 221 in FIG. 2.

As shown in FIG. 3, the current comparator CMPC compares the secondary current IS with the current threshold value ITH to generate a current comparison signal SCPC. According to an embodiment of the present invention, when the secondary current IS is less than the current threshold value ITH, the current comparator CMPC enables the current comparison signal SCPC. According to another embodiment of the present invention, when the secondary current IS is not less than the current threshold ITH, the current comparator CMPC disables the current comparison signal SCPC.

According to some embodiments of the present invention, after the first signal-generation circuit 211 enables the second signal S2 and the secondary current IS is less than the current threshold ITH, the first signal-generation circuit 211 disables the second signal S2 based on the enabled current comparison signal SCPC, thereby turning off the second switch SW2. In other words, when the secondary current IS drops to near zero, the control circuit 110 turns off the second switch SW2, thereby stopping the supply of power to the second output voltage VOUT2. According to some embodiments of the present invention, when the transformer TM finishes demagnetization, the control circuit 110 immediately turns off the second switch SW2.

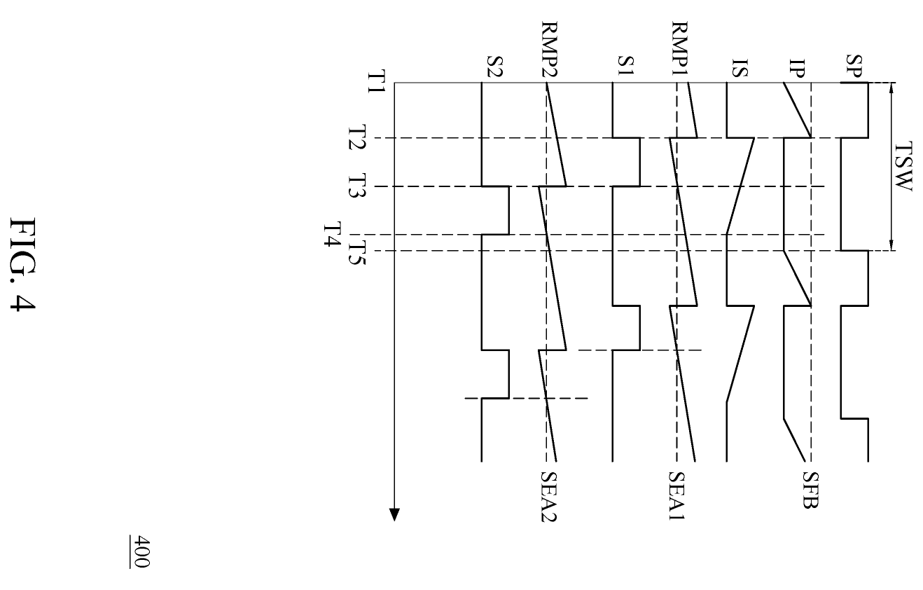

FIG. 4 shows a waveform diagram of a power conversion circuit in accordance with an embodiment of the present invention. The following description of the waveform 400 will be accompanied by the power conversion circuit 200 in FIG. 2 and the power conversion circuit 300 in FIG. 3 for detailed explanation.

As shown in FIG. 4, at the first time point T1, the primary control signal SP is enabled to turn on the primary switch SWP, magnetizing the transformer TM. Between the first time point T1 and the second time point T2, the primary current IP increases linearly. At the second time point T2, the primary control signal SP is disabled to turn off the primary switch SWP, demagnetizing the transformer TM to generate a secondary current IS.

When the transformer TM begins to demagnetize at the second time point T2 to generate a secondary current IS, the first signal-generation circuit 211 enables the first signal S1 to turn on the first switch SW1, causing the secondary current IS to charge the first output capacitor COUT1 to generate the first output voltage VOUT1.

When the first sawtooth wave RMP1 rises to a level not less than the first error signal SEA1 at the third time point T3, the first signal-generation circuit 211 disables the first signal S1 based on the disabled first comparison signal SCP1, thereby turning off the first switch SW1. Furthermore, when the first signal-generation circuit 211 disables the first signal S1 at the third time point T3, it simultaneously enables the second signal S2, thereby turning on the second switch SW2.

In other words, when the first sawtooth wave RMP1 is not less than the first error signal SEA1, the first signal-generation circuit 211 disables the first signal S1 and enables the second signal S2 based on the disabled first comparison signal SCP1, thereby turning off the first switch SW1 and turning on the second switch SW2, causing the secondary current IS to stop supplying power to the first output voltage VOUT1 and start supplying power to the second output voltage VOUT2 at the third time point T3.

When the second sawtooth wave RMP2 rises to not less than the second error signal SEA2 at the fourth time point T4, the second signal-generation circuit 221 disables the second signal S2 based on the disabled second comparison signal SCP2, thereby turning off the second switch SW2. According to some embodiments of the present invention, the control circuit 110 determines the on-time of the first switch SW1 based on the first output voltage VOUT1, and determines the on-time of the second switch SW2 based on the second output voltage VOUT2.

According to other embodiments of the present invention, since the secondary current IS drops to zero at the fourth time point T4, the first signal-generation circuit 211 can disable the second signal S2 based on the secondary current IS dropping to zero (or the secondary current IS dropping below a threshold value), thereby turning off the second switch SW2. In other words, in the embodiment of FIG. 3, the control circuit 110 determines the on-time of the first switch SW1 based on the first output voltage VOUT1, and determines the on-time of the second switch SW2 based on the secondary current IS.

At the fifth time point T5, the isolation circuit 222 and the third signal-generation circuit 223 enable the primary control signal SP based on the first error signal SEA1 and the second error signal SEA2, thereby turning on the primary switch SWP. As shown in FIG. 4, the period from the first time point T1 to the fifth time point T5 constitute the switching time TSW. According to some embodiments of the present invention, the isolation circuit 222 and the third signal-generation circuit 223 can control the enable period of the primary control signal SP, thereby adjusting the on-time of the primary switch SWP. According to some embodiments of the present invention, when the third signal-generation circuit 223 turns on the primary switch SWP at the fifth time point T5, the isolation circuit 222 and the third signal-generation circuit 223 determine the length of the on-time of the primary switch SWP based on the first error signal SEA1 and the second error signal SEA2.

For example, the output power of the first output voltage VOUT1 suddenly increases between the third time point T3 and the fourth time point T4, causing the voltage value of the first output voltage VOUT1 to decrease. The isolation circuit 222 and the third signal-generation circuit 223 can determine that the first output voltage VOUT1 requires more energy based on the first error signal SEA1 to extend the on-time of the primary switch SWP, thereby increasing the maximum value of the primary current IP.

According to an embodiment of the present invention, the period from the first time point T1 to the second time point T2 is the magnetization period of the transformer TM. According to another embodiment of the present invention, the period from the second time point T2 to the fourth time point T4 is the demagnetization period of the transformer TM.

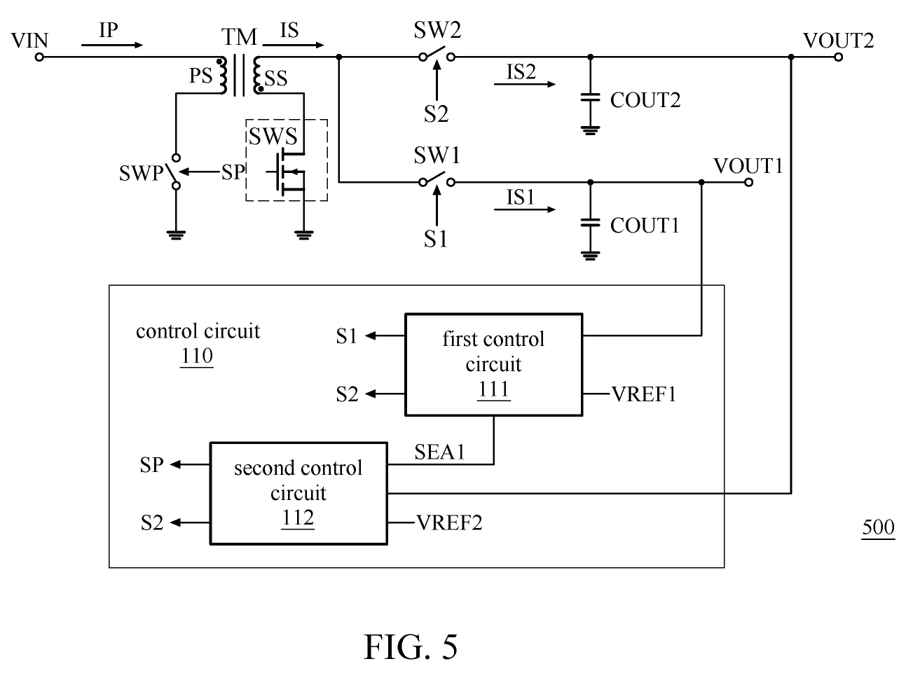

FIG. 5 shows a schematic diagram of a power conversion circuit in accordance with yet another embodiment of the present invention. Compared with the power conversion circuit 100 of FIG. 1, the power conversion circuit 500 further includes a secondary switch SWS. As shown in FIG. 5, the first switch SW1 and the second switch SW2 are coupled to one terminal of the secondary coil SS, and the secondary switch SWS is coupled between the other terminal of the secondary coil SS and the ground.

When the primary switch SWP is turned on, the primary current IP flows from the input voltage VIN through the primary coil PS to the ground, such that the current direction of the secondary current IS is from the first switch SW1 or the second switch SW2 to the secondary coil SS. At this time, the secondary switch SWS is turned off, preventing the first output voltage VOUT1 and the second output voltage VOUT2 from discharging through the secondary coil SS.

When the primary switch SWP is turned off, the secondary switch SWS is turned on, allowing the secondary current IS to supply power to the first output voltage VOUT1 and the second output voltage VOUT2. In other words, when the transformer TM is magnetized, the secondary switch SWS is turned off to prevent the first output voltage VOUT1 and the second output voltage VOUT2 from discharging through the secondary coil SS. When the transformer TM is demagnetized, the secondary switch SWS is turned on, allowing the secondary current IS to supply power to either the first output voltage VOUT1 or the second output voltage VOUT2. According to some embodiments of the present invention, when the primary switch SWP is turned on, the secondary switch SWS is turned off; when the primary switch SWP is turned off, the secondary switch SWS is turned on.

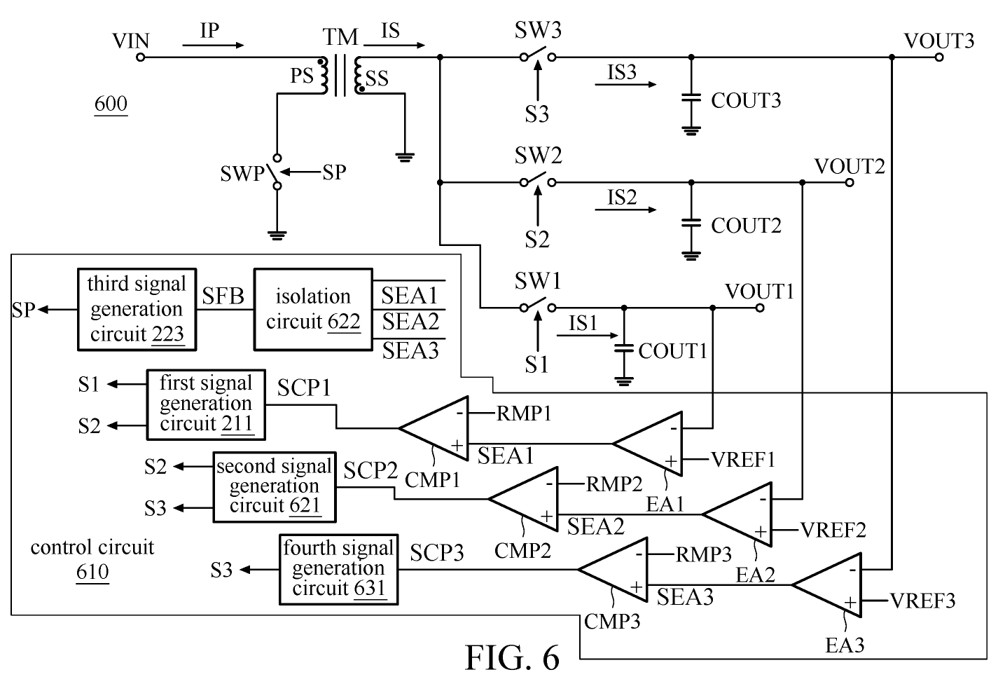

FIG. 6 shows a schematic diagram of a power conversion circuit in accordance with yet another embodiment of the present invention. Compared with the power conversion circuit 200 of FIG. 2, the power conversion circuit 600 further includes a third switch SW3 and a third output capacitor COUT3, and the control circuit 110 of FIG. 2 is replaced by a control circuit 610.

As shown in FIG. 6, the third switch SW3 charges the third output capacitor COUT3 with a secondary current IS based on a third signal S3, thereby generating a third output voltage VOUT3. In other words, the third switch SW3 generates a third supply current IS3 by the secondary current IS, and the third supply current IS3 is configured to charge the third output capacitor COUT3 to generate the third output voltage VOUT3.

Compared with the control circuit 110 of FIG. 2, the second signal-generation circuit 221 of FIG. 2 is replaced by a second signal-generation circuit 621. According to some embodiments of the present invention, when the second signal-generation circuit 621 disables the second signal S2 based on the disabled second comparison signal SCP2, the second signal-generation circuit 621 simultaneously enables the third signal S3.

Compared to the control circuit 110 in FIG. 2, the control circuit 610 further includes a third error amplifier EA3, a third comparator CMP3, and a fourth signal-generation circuit 631. The third error amplifier EA3 generates a third error signal SEA3 based on the difference between the third output voltage VOUT3 and the third reference voltage VREF3. According to an embodiment of the present invention, when the third output voltage VOUT3 decreases, the third error signal SEA3 increases. According to another embodiment of the present invention, when the third output voltage VOUT3 increases, the third error signal SEA3 decreases.

In other words, the third error amplifier EA3 amplifies the difference between the third output voltage VOUT3 and the third reference voltage VREF3 to generate the third error signal SEA3. The third comparator CMP3 compares the third error signal SEA3 and the third sawtooth wave RMP3 to generate a third comparison signal SCP3. The fourth signal-generation circuit 631 generates a third signal S3 based on the third comparison signal SCP3. According to some embodiments of the present invention, when the third sawtooth wave RMP3 rises to a level less than the third error signal SEA3, the fourth signal-generation circuit 631 disables the third signal S3 based on the disabled third comparison signal SCP3, thereby turning off the third switch SW3.

Compared to the control circuit 110 in FIG. 2, the isolation circuit 622 of the control circuit 610 generates a feedback signal SFB based on the first error signal SEA1, the second error signal SEA2, and the third error signal SEA3. Furthermore, the third signal-generation circuit 223 generates a primary control signal SP based on the feedback signal SFB generated by the isolation circuit 622. In other words, the isolation circuit 622 and the third signal-generation circuit 223 adjust the on-time of the primary switch SWP based on the first error signal SEA1, the second error signal SEA2, and the third error signal SEA3.

According to some embodiments of the present invention, the first signal-generation circuit 211 is configured to determine the ratio of the period of supplying power to the first output voltage VOUT1 to the demagnetization period of the transformer TM, and the demagnetization period minus the period of supplying power to the first output voltage VOUT1 is configured to power the second output voltage VOUT2 and the third output voltage VOUT3. The second signal-generation circuit 621 is configured to determine the period of supplying power to the second output voltage VOUT2, and the remaining demagnetization period is configured to power the third output voltage VOUT3.

Furthermore, when the remaining energy of the secondary coil SS is insufficient to power the third output voltage VOUT3, or when the output power of any of the first output voltage VOUT1, second output voltage VOUT2, and third output voltage VOUT3 suddenly increases, the third signal-generation circuit 223 extends the on-time of the primary switch SWP, thereby extending the magnetization period of the transformer TM, so that the transformer TM has more energy to power the first output voltage VOUT1, second output voltage VOUT2, and third output voltage VOUT3.

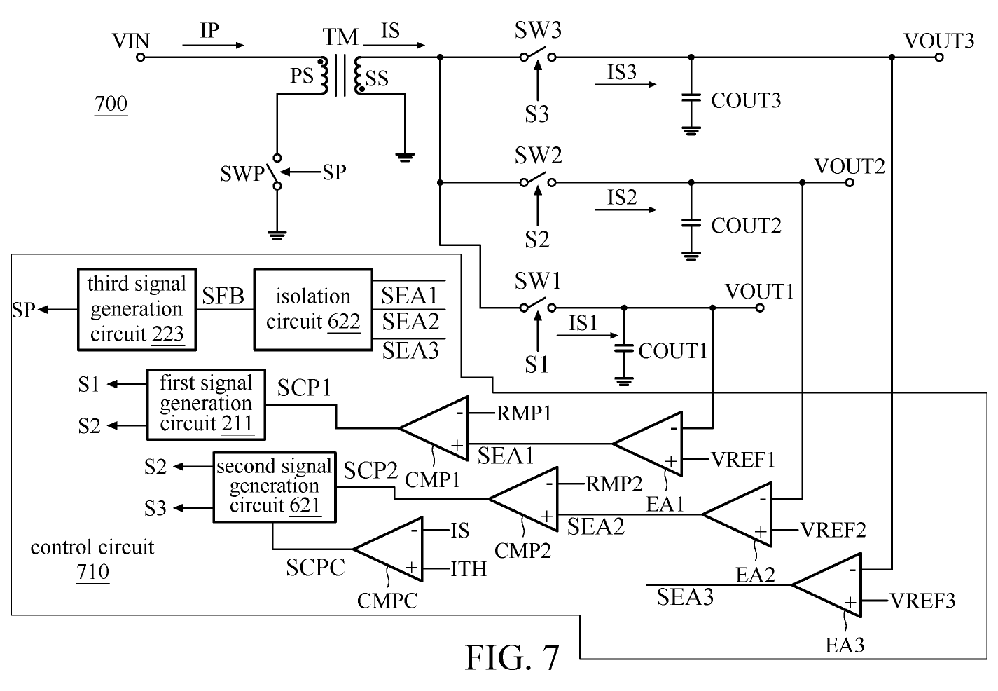

FIG. 7 shows a schematic diagram of a power conversion circuit in accordance with yet another embodiment of the present invention. Compared with the control circuit 610 of FIG. 6, the control circuit 710 of the power conversion circuit 700 uses a current comparator CMPC to replace the third comparator CMP3 and the fourth signal-generation circuit 631 of FIG. 6.

As shown in FIG. 7, the current comparator CMPC is configured to compare the secondary current IS and the current threshold value ITH to generate a current comparison signal SCPC. According to an embodiment of the present invention, when the secondary current IS is less than the current threshold ITH, the current comparator CMPC enables the current comparison signal SCPC. According to another embodiment of the present invention, when the secondary current IS is not less than the current threshold ITH, the current comparator CMPC disables the current comparison signal SCPC.

According to some embodiments of the present invention, after the second signal-generation circuit 621 enables the third signal S3 and the secondary current IS is less than the current threshold ITH, the second signal-generation circuit 621 disables the third signal S3 based on the enabled current comparison signal SCPC, thereby turning off the third switch SW3. In other words, when the secondary current IS drops to near zero, the control circuit 710 turns off the third switch SW3, thereby stopping the supply of power to the third output voltage VOUT3. According to some embodiments of the present invention, when the transformer TM finishes demagnetization, the control circuit 710 immediately turns off the third switch SW3.

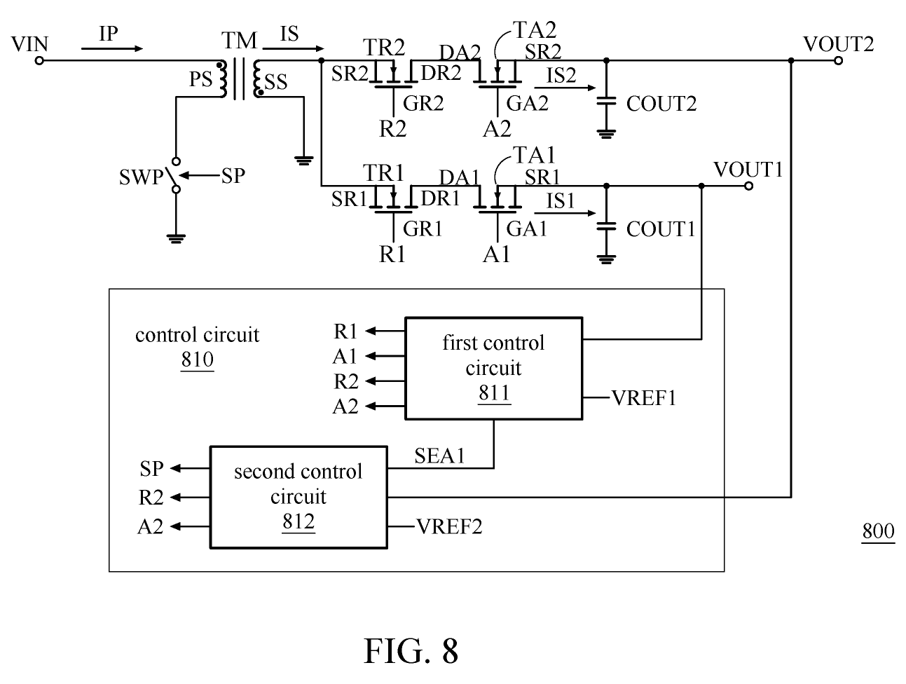

FIG. 8 shows a schematic diagram of a power conversion circuit in accordance with yet another embodiment of the present invention. Compared the power conversion circuit 800 to the power conversion circuit 100 in FIG. 1, the first switch SW1 in FIG. 1 is replaced by the first rectification transistor TR1 and the first blocking transistor TA1, and the second switch SW2 in FIG. 1 is replaced by the second rectification transistor TR2 and the second blocking transistor TA2. Furthermore, the control circuit 110 in FIG. 1 is replaced by the control circuit 810.

The first rectification transistor TR1 includes a first rectification gate terminal GR1, a first rectification drain terminal DR1, and a first rectification source terminal SR1. The first blocking transistor TA1 includes a first blocking gate terminal GA1, a first blocking drain terminal DA1, and a first blocking source terminal SA1. The first rectification gate terminal GR1 receives the first rectification signal R1. The first rectification drain terminal DR1 is electrically connected to the first blocking drain terminal DA1. The first rectification source terminal SR1 receives the secondary current IS. The first blocking gate terminal GA1 receives the first blocking signal A1. The first blocking source terminal SA1 is coupled to the first output voltage VOUT1.

The second rectification transistor TR2 includes a second rectification gate terminal GR2, a second rectification drain terminal DR2, and a second rectification source terminal SR2. The second blocking transistor TA2 includes a second blocking gate terminal GA2, a second blocking drain terminal DA2, and a second blocking source terminal SA2. The second rectification gate terminal GR2 receives the second rectification signal R2. The second rectification drain terminal DR2 is electrically connected to the second blocking drain terminal DA2. The second rectification source terminal SR2 receives the secondary current IS. The second blocking gate terminal GA2 receives the second blocking signal A2. The second blocking source terminal SA2 is coupled to the second output voltage VOUT2.

As shown in FIG. 8, the control circuit 810 includes a first control circuit 811 and a second control circuit 812. The first control circuit 811 generates a first rectification signal R1, a first blocking signal A1, a second rectification signal R2, and a second blocking signal A2 based on the first output voltage VOUT1, and generates a first error signal SEA1 based on the difference between the first output voltage VOUT1 and the first reference voltage VREF1. The second control circuit 112 generates a primary control signal SP based on the first error signal SEA1, the second output voltage VOUT2, and the second reference voltage VREF2, and generates a second rectification signal R2 and a second blocking signal A2 based on the second output voltage VOUT2.

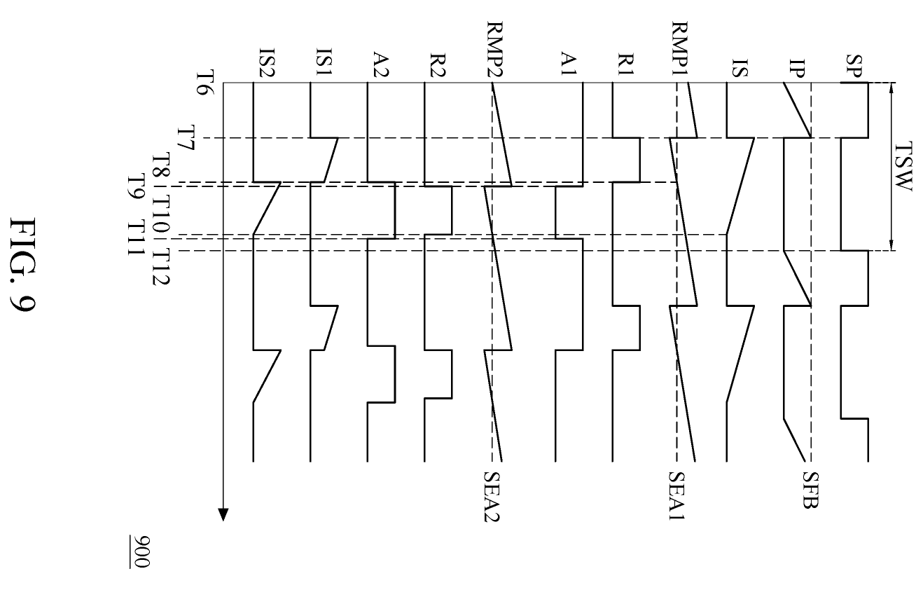

FIG. 9 shows a waveform diagram of a power conversion circuit in accordance with another embodiment of the present invention. The following description of waveform 900 will be provided in conjunction with the power conversion circuit 800 in FIG. 8 for detailed explanation.

As shown in FIG. 9, at the sixth time point T6, the primary control signal SP is enabled, turning on the primary switch SWP, causing the transformer TM to be magnetized. From the sixth time point T6 to the seventh time point T7, the primary current IP increases linearly. At the seventh time point T7, since the primary current IP is not less than the feedback signal SFB, the primary control signal SP is disabled to turn off the primary switch SWP, causing the transformer TM to be demagnetized to generate a secondary current IS.

According to some embodiments of the present invention, the power conversion circuit 800 may include a current detection circuit (not shown in FIG. 8) for detecting the primary current IP to generate a current detection signal. When the current detection signal is not less than the feedback signal SFB, the second control circuit 812 turns off the primary switch SWP at the seventh time point T7. The primary current IP is configured to represent the current detection signal in FIG. 9 for illustration and explanation, but this is not intended to be limited thereto.

When the transformer TM begins demagnetization to generate a secondary current IS at the seventh time point T7, the first rectification signal R1 is simultaneously enabled to turn on the first rectification transistor TR1. Combined with the already turned-on first blocking transistor TA1, this causes the secondary current IS to charge the first output capacitor COUT1 to generate the first output voltage VOUT1. As shown in FIGS. 8 and 9, from time point T7 to time point T8, the secondary current IS flows through the first rectification transistor TR1 and the first blocking transistor TA1 to generate a first supply current IS1 that charges the first output capacitor COUT1.

When the first sawtooth wave RMP1 rises to a level not less than the first error signal SEA1 at time point T8, the first rectification signal R1 is disabled, the first blocking signal A1 remains enabled, and the second blocking signal A2 is enabled, causing the first rectification transistor TR1 to turn off, the first blocking transistor TA1 to remain on, and the second blocking transistor TA2 to turn on.

According to some embodiments of the present invention, since the first rectification transistor TR1 and the second rectification transistor TR2 are turned off and the first blocking transistor TA1 and the second blocking transistor TA2 are turned on between the eighth time point T8 and the ninth time point T9, the secondary current IS supplies power to one of the first output voltage VOUT1 and the second output voltage VOUT2 having the lowest voltage value through the parasitic diode of the first rectification transistor TR1 or the second rectification transistor TR2.

In the embodiment of FIG. 9, the explanation is based on the example that the voltage value of the second output voltage VOUT2 is less than the voltage value of the first output voltage VOUT1, but it is not intended to be limited thereto. As shown in the embodiment of FIG. 9, since the second output voltage VOUT2 is less than the first output voltage VOUT1, the second output voltage VOUT2 is powered during the period from the eighth time point T8 to the ninth time point T9. Furthermore, when both the first blocking transistor TA1 and the second blocking transistor TA2 are turned on, the parasitic diode of the first rectification transistor TR1 and the parasitic diode of the second rectification transistor TR2 prevent the first output voltage VOUT1 and the second output voltage VOUT2 from powering the secondary coil SS, and also prevent the first output voltage VOUT1 and the second output voltage VOUT2 from powering each other.

At the ninth time point T9, the second rectification signal R2 is enabled and the first blocking signal A1 is disabled, causing the second rectification transistor TR2 to be turned on and the first blocking transistor TA1 to be turned off. In other words, after the ninth time point T9, the power is supplied to the second output voltage VOUT2. As shown in FIG. 9, between the ninth time point T9 and the tenth time point T10, the secondary current IS flows through the second rectification transistor TR2 and the second blocking transistor TA2 to generate a second supply current IS2 that charges the second output capacitor COUT2.

According to an embodiment of the present invention, at the tenth time point T10, the second sawtooth wave RMP2 rises to a level not less than the second error signal SEA2, causing the second rectification signal R2 to be disabled and the second rectification transistor TR2 to be turned off. According to another embodiment of the present invention, since the secondary current IS drops to zero at the tenth time point T10, the control circuit 810 can disable the second signal S2 based on the secondary current IS dropping to zero (or the secondary current IS dropping below the current threshold value), thereby turning off the second switch SW2. At the eleventh time point T11, the first blocking signal A1 is enabled and the second blocking signal A2 is disabled, causing the first blocking transistor TA1 to be turned on and the second blocking transistor TA2 to be turned off.

At the twelfth time point T12, the primary control signal SP is enabled to tur on the primary switch SWP, and the on-time of the primary switch SWP is determined according to the first output voltage VOUT1 and the second output voltage VOUT2. According to some embodiments of the present invention, the period from the sixth time point T6 to the twelfth time point T12 is the switching period TSW.

By replacing the first switch SW1 in FIG. 1 with the first rectification transistor TR1 and the first blocking transistor TA1 in FIG. 8 and by replacing the second switch SW2 in FIG. 1 with the second rectification transistor TR2 and the second blocking transistor TA2 in FIG. 8, it prevents that the first output voltage VOUT1 and the second output voltage VOUT2 supply power to each other, and prevents the discharge of the first output voltage VOUT1 and the second output voltage VOUT2 to the ground via the secondary coil SS.

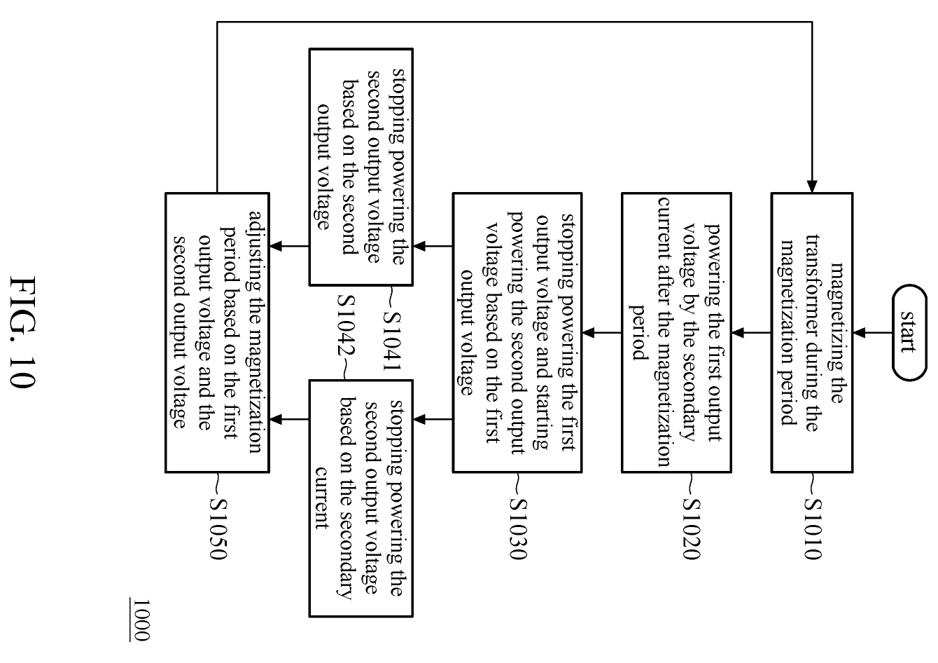

FIG. 10 shows a flowchart of a control method in accordance with an embodiment of the present invention. The following description of the control method 1000 will be accompanied by the power conversion circuit 200 in FIG. 2, the power conversion circuit 300 in FIG. 3, and the waveform diagram 400 in FIG. 4 for detailed explanation.

First, during the magnetization period, the transformer TM is magnetized (step S1010). In the embodiment of FIG. 2, the primary switch SWP is turned on, causing the input voltage VIN to magnetize the transformer TM (i.e., the primary coil PS). In the embodiment of FIG. 4, the magnetization period is between the first time point T1 and the second time point T2, and the demagnetization period is between the second time point T2 and the fourth time point T4. After the magnetization period, the first output voltage VOUT1 is powered by the secondary current IS flowing through the secondary coil SS (step S1020).

Based on the first output voltage VOUT1, the power supplying to the first output voltage VOUT1 is stopped, and the power supplying to the second output voltage VOUT2 is started (step S1030). In the embodiments of FIGS. 2 and 4, when the first sawtooth wave RMP1 rises to a level not less than the first error signal SEA1, the first comparator CMP1 disables the first comparison signal SCP1. The first signal-generation circuit 211, based on the disabled first comparison signal SCP1, disables the first signal S1 and enables the second signal S2 at the third time point T3 in FIG. 4, thereby stopping the supply of power to the first output voltage VOUT1 and starting the supply of power to the second output voltage VOUT2.

According to an embodiment of the present invention, after step S1030, based on the second output voltage VOUT2, the power supply to the second output voltage VOUT2 is stopped (step S1041). In the embodiments of FIGS. 2 and 4, when the second sawtooth wave RMP2 rises to a level not less than the second error signal SEA2, the second comparator CMP2 disables the second comparison signal SCP2. The second signal-generation circuit 221, based on the disabled second comparison signal SCP2, disables the second signal S2 at the fourth time point T4, thereby stopping the supply of power to the second output voltage VOUT2.

According to another embodiment of the present invention, after step S1030, based on the secondary current IS, the power supplying to the second output voltage VOUT2 is stopped (step S1042). In the embodiments of FIGS. 3 and 4, when the secondary current IS drops to zero at the fourth time point T4 (i.e., the secondary current IS drops below the current threshold ITH), the first signal-generation circuit 211 disables the second signal S2, thereby stopping the supply of power to the second output voltage VOUT2.

After step S1041 or step S1042, the magnetization period is adjusted based on the first output voltage VOUT1 and the second output voltage VOUT2 (step S1050), and step S1010 is re-executed for the next switching time TSW. In the embodiment of FIG. 2, the isolation circuit 222 and the third signal-generation circuit 223 generate a primary control signal SP based on the first error signal SEA1 and the second error signal SEA2 to adjust the on-time of the primary switch SWP.

In other words, the isolation circuit 222 and the third signal-generation circuit 223 adjust the on-time of the primary switch SWP based on the difference between the first output voltage VOUT1 and the first reference voltage VREF1, and the difference between the second output voltage VOUT2 and the second reference voltage VREF2, thereby adjusting the magnetization period. After step S1050, step S1010 is re-executed to continue the next switching period TSW, and the transformer TM is magnetized with the adjusted magnetization period.

According to other embodiments of the present invention, the isolation circuit 222 and the third signal-generation circuit 223 adjust the on-time of the primary switch SWP based on the output power of the first output voltage VOUT1 and the output power of the second output voltage VOUT2. In other words, when the output power of the first output voltage VOUT1 increases or the output power of the second output voltage VOUT2 increases, the on-time of the primary switch SWP is extended.

The present invention provides a power conversion circuit having multiple output voltages and a control method thereof. Compared to traditional methods that use multiple secondary coils (or multiple transformers) and additional voltage regulators to stabilize the individual output voltages, the multi-output voltage power conversion circuit proposed herein uses a transformer having a single secondary coil and a plurality of switches to power multiple output voltages in a time-division manner. Since this invention uses a transformer having a single secondary coil and a plurality of switches, it significantly reduces costs and circuit complexity, while also improving conversion efficiency. Furthermore, the multiple output voltages of the power conversion circuit proposed herein can be individually programmed.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil and a secondary coil, wherein the primary coil receives an input voltage, and the secondary coil is configured to generate a secondary current;
a primary switch, coupling the primary coil to a ground based on a primary control signal;
a first switch, powering a first output voltage using the secondary current based on a first signal;
a second switch, powering a second output voltage using the secondary current based on a second signal; and
a control circuit, generating the first signal based on the first output voltage and generating the second signal based on the second output voltage;
wherein the control circuit generates the primary control signal based on the first output voltage and the second output voltage.

2. The power conversion circuit as claimed in claim 1, wherein the control circuit comprises:
a first error amplifier, generating a first error signal based on a difference between the first output voltage and a first reference voltage;
a first comparator, comparing the first error signal with a first sawtooth wave to generate a first comparison signal; and
a first signal-generation circuit, generating the first signal based on the first comparison signal;
wherein when the primary switch is turned off, the control circuit enables the first signal to turn on the first switch;
wherein when the first sawtooth wave is not less than the first error signal, the first signal-generation circuit disables the first signal and simultaneously enables the second signal, so that the first switch is turned off and the second switch is turned on.

3. The power conversion circuit as claimed in claim 2, wherein the first signal-generation circuit disables the second signal based on the secondary current dropping below a current threshold to turn off the second switch.

4. The power conversion circuit as claimed in claim 2, wherein the control circuit further comprises:
a second error amplifier, generating a second error signal based on a difference between the second output voltage and a second reference voltage;
an isolation circuit, generating a feedback signal based on the first error signal and the second error signal; and
a third signal-generation circuit, generating the primary control signal based on the feedback signal.

5. The power conversion circuit as claimed in claim 4, wherein when the first output voltage is less than the first reference voltage or the second output voltage is less than the second reference voltage, the third signal-generation circuit extends an enable period of the primary control signal, thereby extending a magnetization period of the primary coil.

6. The power conversion circuit as claimed in claim 4, wherein the control circuit further comprises:
a current comparator, comparing the secondary current with a current threshold to generate a current comparison signal;
wherein when the secondary current is less than the current threshold, the first signal-generation circuit disables the second signal based on the current comparison signal, thereby turning off the second switch.

7. The power conversion circuit as claimed in claim 4, wherein the control circuit further comprises:
a second comparator, comparing the second error signal to a second sawtooth wave to generate a second comparison signal; and
a second signal-generation circuit, disabling the second signal based on the second comparison signal;
wherein when the second sawtooth wave is not less than the second error signal, the second signal-generation circuit disables the second signal, thereby turning off the second switch.

8. The power conversion circuit as claimed in claim 7, further comprising:
a third switch, powering a third output voltage using the secondary current based on a third signal;
wherein the control circuit further comprises:
a third error amplifier, generating a third error signal based on a difference between the third output voltage and a third reference voltage;
wherein when the second signal-generation circuit disables the second signal, the third signal is simultaneously enabled;
wherein the isolation circuit generates the feedback signal based on the first error signal, the second error signal, and the third error signal.

9. The power conversion circuit as claimed in claim 8, wherein the control circuit further comprises:
a current comparator, comparing the secondary current and a current threshold to generate a current comparison signal;
wherein when the secondary current is less than the current threshold, the second signal-generation circuit disables the third signal based on the current comparison signal, thereby turning off the third switch.

10. The power conversion circuit as claimed in claim 8, wherein the control circuit further comprises:
a third comparator, comparing the third error signal to a third sawtooth wave to generate a third comparison signal; and
a fourth signal-generation circuit, disabling the third signal based on the third comparison signal;
wherein when the third sawtooth wave is not less than the third error signal, the fourth signal-generation circuit disables the third signal, thereby turning off the third switch.

11. The power conversion circuit as claimed in claim 1, further comprising:
a secondary switch, coupled to the secondary coil in series;
wherein when the primary switch is turned on, the secondary switch is turned off;
wherein when the primary switch is turned off, the secondary switch is turned on so that the secondary current powers either the first output voltage or the second output voltage.

12. The power conversion circuit as claimed in claim 1, wherein the first switch comprises:
a first rectification transistor, comprising a first rectification gate terminal, a first rectification drain terminal, and a first rectification source terminal; and
a first blocking transistor, comprising a first blocking gate terminal, a first blocking drain terminal, and a first blocking source terminal;
wherein the first rectification gate terminal receives a first rectification signal, the first rectification drain terminal is coupled to the first blocking drain terminal, and the first rectification source terminal receives the secondary current;
wherein the first blocking gate terminal receives a first blocking signal and the first blocking drain terminal is coupled to the first output voltage.

13. The power conversion circuit as claimed in claim 12, wherein the second switch comprises:
a second rectification transistor, comprising a second rectification gate terminal, a second rectification drain terminal, and a second rectification source terminal; and
a second blocking transistor, comprising a second blocking gate terminal, a second blocking drain terminal, and a second blocking source terminal;
wherein the second rectification gate terminal receives a second rectification signal, the second rectification drain terminal is coupled to the second blocking drain terminal, and the second rectification source terminal receives the secondary current;
wherein the second blocking gate terminal receives a second blocking signal, and the second blocking source terminal is coupled to the second output voltage.

14. The power conversion circuit as claimed in claim 13, wherein an on-time of the first rectification transistor does not overlap an on-time of the second rectification transistor.

15. The power conversion circuit as claimed in claim 13, wherein during a first period, the first rectification transistor and the first blocking transistor are both turned on, causing the secondary current to power the first output voltage;
wherein during a second period after the first period, the first rectification transistor is turned off and the first blocking transistor and the second blocking transistor are both turned on, causing the secondary current to power either the first output voltage or the second output voltage having a lower voltage value;
wherein during a third period after the second period, the first blocking transistor is turned off and the second rectification transistor is turned on, causing the secondary current to power the second output voltage.

16. A control method for controlling a power conversion circuit to convert an input voltage into a first output voltage and a second output voltage, wherein the power conversion circuit comprises a transformer, wherein the transformer comprises a primary coil and a secondary coil, wherein the control method comprises:
during a magnetization period, magnetizing the primary coil;
after the magnetization period, powering the first output voltage using a secondary current of the secondary coil;
stopping powering the first output voltage and starting powering the second output voltage based on the first output voltage; and
adjusting the magnetization period based on the first output voltage and the second output voltage.

17. The control method as claimed in claim 16, further comprising:
stopping powering the second output voltage based on the second output voltage.

18. The control method as claimed in claim 16, further comprising:
stopping powering the second output voltage based on the secondary current.

19. The control method as claimed in claim 16, wherein the step of adjusting the magnetization period based on the first output voltage and the second output voltage further comprises:
generating a first error signal based on a difference between the first output voltage and the first reference voltage;
generating a second error signal based on a difference between the second output voltage and the second reference voltage; and
determining the magnetization period based on the first error signal and the second error signal;
wherein when the first output voltage is less than the first reference voltage, extending the magnetization period;
wherein when the second output voltage is less than the second reference voltage, extending the magnetization period.

20. The control method as claimed in claim 16, wherein the step of adjusting the magnetization period based on the first output voltage and the second output voltage further comprises:
determining output power of the first output voltage and output power of the second output voltage;
when the output power of the first output voltage increases, extending the magnetization period; and
when the output power of the second output voltage increases, extending the magnetization period.

21. The control method as claimed in claim 16, wherein the secondary current powers the first output voltage through a first rectification transistor and a first blocking transistor, and the secondary current powers the second output voltage through a second rectification transistor and a second blocking transistor;
wherein a source terminal of the first rectification transistor receives the secondary current, a drain terminal of the first rectification transistor is coupled to a drain terminal of the first blocking transistor, and a source terminal of the first blocking transistor is coupled to the first output voltage;
wherein a source terminal of the second rectification transistor receives the secondary current, a drain terminal of the second rectification transistor is coupled to a drain terminal of the second blocking transistor, and a source terminal of the second blocking transistor is coupled to the second output voltage.

22. The control method as claimed in claim 21, further comprising:
during a first period, simultaneously turning on the first rectification transistor and the first blocking transistor, causing the secondary current to power the first output voltage;
during a second period after the first period, turning off the first rectification transistor and turning on the first blocking transistor and the second blocking transistor, causing the secondary current to power either the first output voltage or the second output voltage having a lower voltage value; and
during a third period after the second period, turning off the first blocking transistor and turning on the second rectification transistor, causing the secondary current to power the second output voltage.
